(19) United States
(12) Patent Application Publication
(10) Pub. No.: US 2010/0009002 A1
(43) Pub. Date: Jan. 14, 2010

(54) GUAVA TREE EXTRACT INSECT CONTROL

(75) Inventor: Rocco Simonetta, Prairie Grove, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: TROPICANA PRODUCTS, INC., Bradenton, FL (US)

(21) Appl. No.: 12/502,856

(22) Filed: Jul. 14, 2009

Related U.S. Application Data
(60) Provisional application No. 61/080,457, filed on Jul. 14, 2008.

(51) Int. Cl. A01N 65/08; A01P 7/04

(52) U.S. Cl. 424/490; 424/769

(57) ABSTRACT

The invention relates to insect control compositions, and more particularly to repellent and attractant compositions that may be used to control insect populations from damaging citrus trees. It has been found that the Asian citrus psyllid, the vector that transmits citrus greening disease, or Huanglongbing (HLB), is attracted to certain compounds in guava tree extracts. The guava-based compounds may be used to attract psyllids to traps to monitor populations and disrupt breeding cycles.

### FIELD OF THE INVENTION

The invention relates to insect control compositions, and more particularly to repellent and attractant compositions that may be used to control insect populations from damaging citrus trees.

### BACKGROUND OF THE INVENTION

Since the time that the first explorers sailed to the New World, non-native diseases, plants and animals have traveled to locations where there is neither resistance to the disease, nor predators to keep populations of non-native plants and animals in check. Some diseases, such as small pox, were inadvertently introduced with devastating consequences on indigenous peoples. Dutch elm disease resulted in the destruction of trees that once shaded cities and towns throughout North America, which continues today. Other plant species, such as purple loosestrife, were transported to far-away lands for their decorative value. Non-native animals have both inadvertently (Norwegian rats, worldwide) and intentionally (hares, Australia) been introduced outside their original ranges.

Many species of insects have been introduced to new lands where there are no natural controls or predators. The gypsy moth and the emerald ash borer beetle are examples of non-native insects that have devastated native North American tree species and continue to spread and increase their respective areas of infestation. The larvae of the gypsy moth feed on the foliage of trees, which leads to tree decline and, if subject to repeated stress, death. The larvae of the emerald ash borer beetle tunnels under the bark of the trees it infests, cutting off the flow of nutrients to the branches and leaves, killing the tree.

Another example of a non-native pest is the Mediterranean fruit fly, or Med fly. The Med fly is a destructive insect that infests and destroys many types of tree fruits, including citrus, peaches, pears and apples. The Med fly lays its eggs under the skin of the fruit, and the larvae feed on the pulp and tunnel through the fruit, rendering the fruit inedible. The first infestation in the United States was in 1929 in Florida. Med fly infestations are controlled through the use of quarantines and the widespread application of pesticides, such as Malathion®. A recent infestation near Tampa Bay, Fla. threatened citrus production and cost approximate $25 million.

A more recent invasive disease to threaten citrus trees is known as “citrus greening” or Huanglongbing (HLB). The disease is a systemic bacterial disease, caused by a phloem-limited bacterium, Liberibacter spp., which occurs throughout Asia, Africa, and the Americas. Symptoms of greening disease in citrus trees include stunted growth, sparsely foliated branches, unseasonal bloom, leaf and fruit drop, and twig dieback. Young leaves are chlorotic, with green banding along the major veins. Mature leaves have yellowish-green patches between veins, and midribs are yellow. In severe cases, all of the leaves become chlorotic and have scattered spots of green. Fruits on greened trees are small, generally lopsided, underdeveloped, unevenly colored, hard, and poor in juice. The columella is almost always curved in sweet orange fruits and is apparently the most reliable diagnostic symptom of greening. Most seeds in diseased fruits are small and dark colored.

Several years are generally required before a greening-infected tree will manifest visual symptoms of leaf chlorosis, stem dieback, and stunted growth. Infected trees typically die 4-6 years after initial infection. Once the tree is infected, there is no cure for the disease. Newly planted citrus orchards are particularly susceptible to greening disease and young trees will die approximately 2 years after initial infection. In cases of early infection, young trees never become productive. Greening-positive trees are uprooted and burned.

Three distinct species of the pathogen have been described in the scientific literature. One species, Liberibacter asiaticus, the Asian strain, is native to Asia, but has also been found in Florida and Brazil. The Asian strain is found in warm locales and is typically transmitted by the Asian citrus psyllid, Diaphorina citri Kuwayama (hereinafter “psyllid” or “psyllids”). In the field, psyllids are the vector that transmits and spreads the greening disease from nearby infected plants. The disease may also be transmitted in citrus nurseries by the use of grafts cut from infected, asymptomatic trees.

Asian citrus psyllids resemble miniature cicadas and are sometimes called jumping plant lice. The Asian citrus psyllid is 3 to 4 mm long with a brown mottled body, light brown head, mottled and banded wings, antennae with black tips and two small light brown spots on middle segments. Live Asian citrus psyllids appear dusty due to a whitish, waxy secretion covering the body.

Psyllids lay their eggs on tips of growing shoots on and between unfurling leaves. Female psyllids may lay more than 800 eggs during their lives. During their growth, psyllid nymphs pass through five instars. The total life cycle for the Asian citrus psyllid is reported to be from 15 to 47 days, depending upon the season. Adult psyllids may live for several months. The psyllids may produce nine to 10 generations a year, with as many as 16 generations observed in field cages.

Asian citrus psyllids acquire the citrus greening pathogen after feeding on a diseased plant for as little as 15 to 30 minutes. However an adult psyllid need not feed on a diseased plant if it grew from an egg laid on an infected tree. Adult psyllids are able to transmit the greening pathogen and infect a new tree at a low rate with a minimum of 15 minutes of feeding. One hundred percent infection was obtained when the psyllids fed for one hour or more.

Current management methods to reduce the spread psyllid populations depend on insecticides, parasitoids, predators, and pathogens specific to the psyllid that requires control. Natural enemies of Asian citrus psyllid include syrphids, chrysopids, at least 12 species of coccinellids, and several species of parasitic wasps, the most important of which is Tamarixia radiata, which was introduced in Florida. The use of broad-spectrum, persistent insecticides has certain drawback in that the chemicals also kill other beneficial insects, including the natural enemies of psyllids, and can contaminate surface waters due to runoff.

Recently, a promising natural alternative to the use of insecticides was noted in citrus groves in Viet Nam. Citrus trees are raised in groves containing other fruits including, but not limited to, pineapples, bananas, and guava. Asian citrus psyllids were not found in citrus groves intercropped with guava trees. Naturally produced volatile chemicals from the guava trees alters the behavior of the psyllids and prevents the citrus trees from becoming infected with the disease. Citrus groves interplanted with guava trees were found to be free of greening disease, while citrus groves interplanted with only bananas and pineapples were found to be infected with the disease.

The guava is a small tree that is thought to have originated in Central America. The plant belongs to the myrtle family, which also includes other species known for their insect-repelling essential oils and antiseptic compounds, for example, eucalyptus, tea trees, and clove. Guava trees are widely grown in the tropics for food and medicinal purposes. The guava tree has a long history of traditional use of bark and leaf extracts that have an in vitro toxic effect on numerous bacteria. Guava extracts are used as herbal antibiotics with significant antibacterial, antifungal, anti-yeast, anti-amoebic, and antimalarial actions. The leaves of guava are rich in essential oils and flavonoids.

There are over 240 volatile compounds that have been identified in guava trees. The compounds include, but are not limited to, in the fruit: hexanal, γ-butyrolactone, (E)-2-hexanal, (E,E)-2,4-hexadienal, (Z)-3-hexenal, (Z)-2-hexenal, (Z)-3-hexenyl acetate, phenol, β-caryophyllene, nerolidol, 3-phenylpropyl acetate, caryophyllene oxide, pentane-2-thiol, 3-penten-2-ol, 2-butenyl acetate, acetic acid, 3-hydroxy-2-butanone, 3-methyl-1-butanol, 2, 3-butanediol, 3-methylbutanoic acid, (Z)-3-hexen-1-ol, 6-methyl-5-hepten-2-one, limonene, octanol, ethyl octanoate, 3-phenylpropanol, cinnamyl alcohol, and α-copaene. The leaves contain essential oil that includes: α-pinene, β-pinene, limonene, menthol, terpenyl acetate, isopropyl alcohol, longicyclene, caryophyllene, β-bisabolene, caryophyllene oxide, β-copanene, farnesene, humulene, selinene, cardinene, curcumene, nerolidiol, β-sitosterol, ursolic, crategolic, guayavolic acids, eugenol, mallic acid and tannin, cineol, four triterpenic acids, quercetin, its 3-L-4-4-arabinofuranoside (avicularin) and its 3-L-4-pyranoside. Other components of the essential oil from guava leaves include: caryophyllene, copaene, [1aR-(1a α-, 4a α-, 7 α-, 7a β-, 7b α-)]-decahydro-1,1,7-trimethyl-4-methylene-1H-cycloprop[e]azulene, eucalyptol, guajavolide (2 α-, 3 β-, 6 β-,23-tetrahydroxyurs-12-en-28,20 β-olide), guavenoic acid (2 α-, 3 β-, 6 β-, 23-tetrahydroxyurs-12, 20 (30)-dien-28-oic acid), and a triterpene oleanolic acid.

In Viet Nam, guava trees are planted on a one to one ratio with citrus trees, and are spaced relatively close together, approximately 2.5 meters between trees and rows. Guava is grown as a commercial product and not solely for its psyllid control characteristics. In other citrus growing areas, such as the United States, there is less demand for guava fruit. Further, the highly mechanized citrus farming practices of the United States are not easily adapted to the close interplanting of guava and citrus trees as currently practiced in Viet Nam. In addition, the reduction of citrus trees per acre required to accommodate the planting of guava trees would not conform to current, large-scale citrus farming operations. Accordingly, what is needed is the insect control properties of the guava tree without the dedication of productive land within the citrus grove to maintaining the guava trees themselves.

### BRIEF DESCRIPTION OF THE DRAWINGS

FIG. 1 is an example of the results an electoantennogram test performed using a psyllid antenna exposed to a guava extract of the invention.

### SUMMARY OF THE INVENTION

Embodiments of the compositions and method of the present invention resolve many of the difficulties associated with interplanting of guava trees in citrus groves to provide protection from the Asian citrus psyllid, and thus prevent the spread of the citrus greening disease. It has been determined that certain compositions derived from the guava tree provide surprisingly effective psyllid repellant properties, comparable to those of the guava tree itself, without the dedication of space within the citrus grove to guava production. Other compositions derived from the guava tree provide surprisingly effective gender specific attractant properties for the psyllid, which varies with the concentration of the composition employed.

In a first embodiment of the invention, the guava tree extract is combined with a carrier to permit the application of the guava extract to the citrus trees. The guava tree extract may be in liquid form, or microencapsulated. In an embodiment, the guava tree extract is mixed with a carrier, preferably water, and applied to the trees within a citrus grove. Optionally, a surfactant is employed, to allow the guava extract to mix with the carrier and also to adhere to the leaves, fruit, and branches of the citrus trees. The skilled practitioner will be able to select acceptable sprayers or atomizers to effectively apply the guava extract composition to the citrus grove.

In an alternative embodiment, the guava tree extract is microencapsulated and prepared as a dust or powder. The microencapsulated extract can be applied to the citrus grove as a dust, powder, or liquid formulation, mixed with a carrier, preferably water. As the encapsulant degrades in the environment, the guava tree volatiles are released into the air within the citrus grove, providing protection from the psyllids. Employing several encapsulants with differing physical and chemical properties, such as reactivity to ultraviolet light or rates of oxidation, or otherwise changing the composition of the encapsulant, will permit the guava extract volatiles to be released over an extended period of time. The skilled practitioner will be able to select the combination of encapsulants to maximize the period of time during which the guava extract volatiles are released into the citrus grove to be protected.

A further embodiment of the invention is the method of repelling the Asian citrus psyllid from citrus trees by using the compositions of the invention. In one embodiment of the method, a guava tree extract composition is prepared from a concentrated guava tree extract, a carrier, preferably water, and optionally, a surfactant. The composition is applied to a citrus tree in an amount sufficient to effective repel the Asian citrus psyllid. The concentration of the guava extract composition is dependent upon many factors, including the carrier employed, the method and conditions of the application, whether the composition is applied to the citrus tree as a spray, a mist, an aerosol, or a film, or as a dust, a powder or fine particles, and the like. Proper consideration of these factors to provide the necessary concentration of the guava extract volatiles at the citrus tree to be protected are within knowledge of the skilled practitioner.

The guava tree extract composition may be applied to the citrus tree at regular intervals to control and repel the Asian citrus psyllid from citrus tree to be protected, preventing the psyllid from feeding on the tree and thus spreading the citrus greening pathogen. Shorter intervals between applications or higher concentrations of guava tree extract compositions may be used to repel and drive psyllids out of a citrus grove if populations of the insect are discovered. The skilled practitioner will be able to select the appropriate spraying interval and concentration of the guava tree extract composition based on the particular environmental conditions present in a citrus grove to be protected from psyllid invasions and infestations.

A further embodiment of the invention is the use of guava tree extract as an attractant for the psyllid based on the sex of the insect. The guava tree extract is used in traps to capture psyllids. The guava extract when used as an attractant in a trap, can be used to monitor psyllid populations, to track psyllid invasions, assist in making decisions regarding the implementation and efficiency of management techniques. Fractions of the guava extract may be used in gender specific traps. Lower concentrations of the guava extract attract the male insect while higher concentrations attract female psyllids. When used in conjunction with a trap, a guava extract bait attracts psyllids of one gender, effectively reducing the number of insects in the location where the trap is used. The reduction in the population of one gender of psyllids disrupts the mating and reproduction cycle of the insect, resulting in a decline in overall population. The concentration of the guava extract composition used as an attractant is dependent upon many factors, including gender of psyllid to be attracted and trapped, the carrier employed, the method and conditions employed to volatilize the composition, the density of the traps to be used, and the like. Proper consideration of these factors to provide the necessary concentration of the guava extract volatiles to act as an attractant are within knowledge of the skilled practitioner.

### DETAILS OF THE INVENTION

Over the last three decades, commercial citrus growers in Florida have increased the production of their groves by increasing the density of their plantings. In 2004, the average density in Florida orange groves was over 130 trees per acre. Citrus trees are now grown in rows forming hedges, with approximately 25 feet between rows and less than 15 feet between individual trees within each row. Citrus trees grown in dense rows result in more efficient fertilizer uptake from the root systems and the ability to use machinery to both apply crop protection chemicals and harvest the fruit when ripe. The citrus trees are pruned to maximize the amount of solar radiation intercepted by each tree, to optimize the fruit bearing volume of the tree canopy.

While these planting practices optimize the fruit production of the grove, the practices are not conducive to the introduction of other tree species, such as the guava tree. Planting guava trees would require the allocation of land currently in citrus production, and thus reduce the number of citrus-bearing trees per acre. As a result, citrus production within a grove would be reduced if space were set aside for planting other types of trees.

An additional barrier to the widespread interplanting of guava trees in citrus groves is the lack of a commercial market for the guava fruit. The guava fruit is popular in some locations, such as Viet Nam. However, there is no great commercial demand for the fruit in other locations, such as the United States, that economically justify large-scale planting of guava trees at the density required to repel the Asian citrus psyllid from citrus groves. While the preferences of consumers may change over time, the current demand for the guava fruit would not offset the loss of citrus production required to interplant guava trees at the density shown to be effective in Viet Nam.

The guava extract compositions of the invention address the limitations of guava tree intercropping and lack of commercial market for the guava fruit, yet provide protection from the Asian citrus psyllid and the citrus greening disease pathogen the psyllid transmits to healthy citrus trees. By isolating the volatile compounds within the guava tree that repel the psyllid, the embodiments of the invention offer an effective alternative to guava tree interplanting.

The guava extract compositions of the invention can be applied to citrus groves on a regular basis, to protect the trees from the Asian citrus psyllid feeding on and infecting the healthy citrus trees. The compositions may also be applied to non-commercial plants within the citrus family, such as the jasmine orange, which is grown as an ornamental hedge or shrub in tropical and semi-tropical climates. Application of the guava extract compositions to such non-commercial plants will provide the same repellant properties and will limit the sources of the pathogen that can serve as reservoirs of new infections by the spread of the psyllids.

Alternatively, the guava extract compositions may be used in traps to control psyllid populations, monitor psyllid populations, to track psyllid invasions, assist in making decisions regarding the implementation and efficiency of management techniques. The guava extract is used as a bait to attract psyllids to traps where they are captured. Different fractions and concentrations of the guava extract are used to attract the genders of psyllids. Effective concentrations of guava extract range from about 0.001% to 5.0%. Lower concentrations, from about 0.005% to about 0.5% of the guava extract have demonstrated the ability to attract the male psyllid. In addition, higher concentrations, from about 0.5% to 5.0% have attracted female psyllids in initial studies.

When used in conjunction with a trap, guava extract used as bait attracts psyllids of one gender, depending on the concentration used, effectively reducing the number of insects in the location where the trap is used. The reduction in the population of one gender of psyllids disrupts the mating and reproduction cycle of the insect, resulting in a decline in overall population. The concentration of the guava extract composition used as an attractant is dependent upon many factors, including gender of psyllid to be attracted and trapped, the carrier employed, the method and conditions employed to volatilize the composition, the density of the traps to be used, and the like. Proper consideration of these factors to provide the necessary concentration of the guava extract volatiles to act as an attractant are within knowledge of the skilled practitioner.

Compositions of the invention comprise volatile compounds extracted from the guava tree. The extract may be derived from the guava fruit, the leaves of the guava tree, the bark of the guava tree, or combinations thereof. There are over 240 volatile compounds that have been identified in guava trees. The compounds include, but are not limited to, in the fruit: hexanal, y-butyrolactone, (E)-2-hexanal, (E,E)-2,4-hexadienal, (Z)-3-hexenal, (Z)-2-hexenal, (Z)-3-hexenyl acetate, phenol, β-caryophyllene, nerolidol, 3-phenylpropyl acetate, caryophyllene oxide, pentane-2-thiol, 3-penten-2-ol, 2-butenyl acetate, acetic acid, 3-hydroxy-2-butanone, 3-methyl-1-butanol, 2,3-butanediol, 3-methylbutanoic acid, (Z)-3-hexen-1-ol, 6-methyl-5-hepten-2-one, limonene, octanol, ethyl octanoate, 3-phenylpropanol, cinnamyl alcohol, and α-copaene. The leaves contain essential oil that includes: α-pinene, β-pinene, limonene, menthol, terpenyl acetate, isopropyl alcohol, longicyclene, caryophyllene, β-bisabolene, caryophyllene oxide, β-copanene, famesene, humulene, selinene, cardinene, curcumene, nerolidiol, β-sitosterol, ursolic, crategolic, guayavolic acids, eugenol, mallic acid and tannin, cineol, four triterpenic acids, quercetin, its 3-L4-4-arabinofuranoside (avicularin) and its 3-L-4-pyranoside. Other components of the essential oil from guava leaves include: caryophyllene, copaene, [1aR-(1a α-, 4a α-, 7 α-, 7a β-, 7b α-)]-decahydro-1,1, 7-trimethyl-4-methylene-1H-cycloprop[e] azulene, eucalyptol, guajavolide (2 α-, 3 β-, 6β-,23-tetrahydroxyurs-12-en-28,20 β-olide, guavenoic acid (2 α-, 3 β-, 6 β-, 23-tetrahydroxyurs-12,20 (30)-dien-28-oic acid, and a triterpene oleanolic acid.

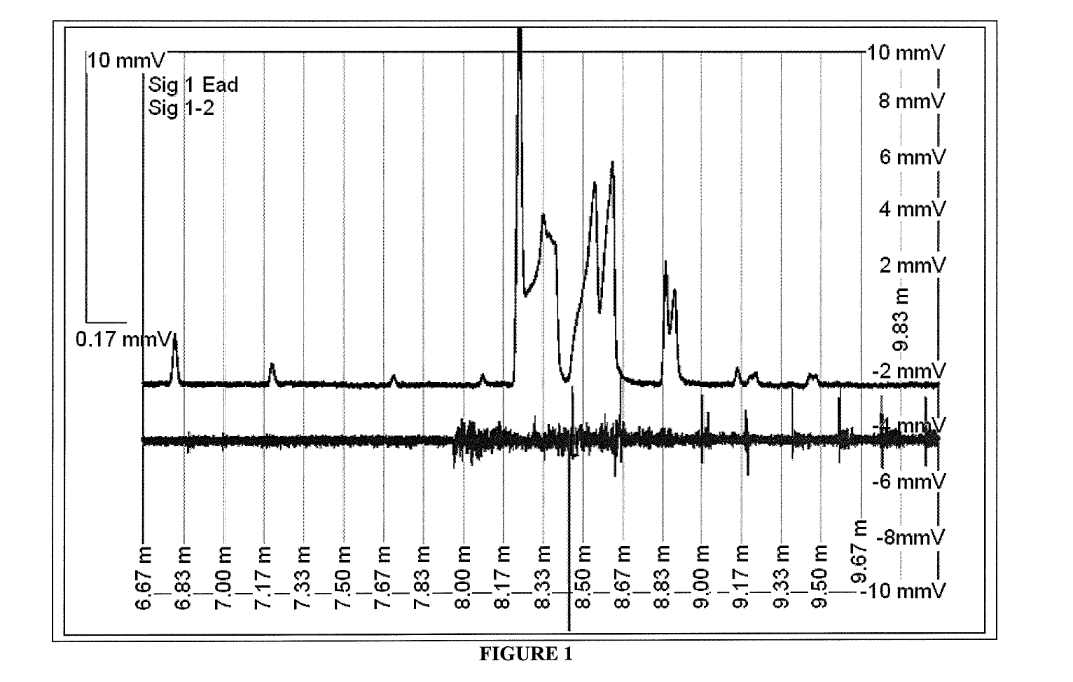

To determine which of the volatiles elicit a response in psyllids, the guava extract compositions are screened using electroantennogram testing employing dissected psyllid antennae. Isolates of the compositions are tested, and those compounds that elicit a response in the psyllid antennae are identified using gas chromatography performed simultaneously with the electroantennogram. Compounds that generate a response in the dissected antennae are further screened by observing the behavior of live psyllids to exposure to the particular volatile compounds. FIG. 1 illustrates the results on one gas chromotograph—electroantennogram test.

Additional tests include applying guava extract compounds to citrus tree branches to determine if the extract attracts or repels psyllids or if the one gender of psyllid has a more pronounced reaction to the guava extract than the other. Those compounds that are observed to preferentially attract only one gender of psyllids are then prepared in compositions and applied as baits in traps to confirm the attractant characteristics of the particular compound. Those compounds that are observed to repel psyllids are then prepared in compositions and applied to a citrus tree to confirm the repellant characteristics of the particular compound.

Analyses conducted on extracts of the guava fruit by electroantennogram using psyllid antennae indicate several volatiles illicit strong antennae responses. To evaluate the effect of guava as a repellant and attractant, a guava fruit extract was prepared by Givaudan Flavors Corporation, 1199 Edison Drive, Cincinnati, Ohio. The extract represents a full range of guava fruit volatiles, mostly from synthetic components. The extract includes approximately 40 to 50 components. The electroantennogram test is performed by first dissecting antennae from the insect's body and then attaching the antennae micro-circuits interfaced to a computer. The gender of the phyllid is noted to determine if the response is particularized to males or females. The volatile chemicals are passed over the dissected antennae. Exposure to certain volatiles causes the antennae to twitch, creating a bio-chemical reaction detected by the micro-circuit. Antennae responses are recorded and shown as blips on a digital recorder. Electroantennogram testing confirms that there are several volatiles from guava that illicit strong antennae responses.

Embodiments of the compositions of the invention may contain one, two, three, four or more volatile compounds from the guava tree. The guava tree extract may be derived from the guava tree or may be reproduced using synthetic constituents, based on the identification of the volatiles determined to comprise the natural extract and to possess psyllid repellant or attractant qualities. The extract may be provided in a concentrated form, and diluted with water prior to application on the citrus trees. A surfactant may optionally be used to facilitate the adherence of the extract to the leaves of the citrus trees to which it is applied. Alternatively, the extract may be provided in a concentrated form to be used as bait in traps to gauge the effectiveness of conventional psyllid control methods, to detect psyllid invasions, to selectively capture one gender of phyllids to disrupt the mating cycle, or simply to attract and kill psyllids.

Embodiments of the psyllid repellant include compositions containing guava tree extract. The concentrations of the guava tree extract in the composition ranges from between 10 to 0.01 percent by volume, preferably between 5 and 0.05 percent by volume and most preferably between 1.0 and 0.1 percent by volume. Preferably, the lowest effective concentration is used to repel the psyllids. A surfactant, such as SilWet L77, may be used in the composition. The surfactant is used in an amount effective to permit the composition to adequately wet and adhere to the leaves of the citrus tree to which it is applied. If a surfactant is used in the composition, it is typically within the range of 1.0 to 0.1 percent by volume.

### EXAMPLE 1

Guava Essence Foliage Application Test: Florida Sweet Orange

| | Citrus Trees per | Number of | Total Trees per |
|---|---|---|---|
| Treatment | Replication | Replications | Treatment |
| Control | 5 | 5 | 25 |
| Guava Tree | 5 | 5 | 25 |
| Extract (0.1%, | | | |
| v/v) | | | |
| Guava Tree | 5 | 5 | 25 |
| Extract (0.5%, | | | |
| v/v) | | | |

Application: hand held power sprayer, treatment applied to foliage runoff, single application, 4 liters aqueous spray per tree
Surfactant: optional, SilWet L77, 0.5% (v/v)
Grove design: 100 trees per acre, 5-7 years old trees
The control and guava tree extract treatments are applied to Florida sweet orange citrus trees. The trees are observed for the presence of psyllids over a period of time.

Embodiments of the gender-specific psyllid attractant include compositions containing guava tree extract. Asian citrus psyllids are known to be attracted to the color yellow and traps using a sticky adhesive are well known in the art. A sticky trap is prepared using a guava extract bait at a concentration of between about 0.5% to about 0.001%. The guava extract may be microencapsulated to permit release of the volatile compounds over an extended period of time. Other means to permit the release of the volatile compounds over desired periods of time as known in the art may also be used. The trap is preferably colored yellow as an addition means to attract the targeted insect. Adult male psyllids are preferentially attracted to and captured by the sticky adhesive on the surface of the trap.

While particular embodiments of the invention have been shown, it will be understood that the invention is not limited thereto since modifications may be made by those skilled in the art, particularly in light of the foregoing teachings. It is, therefore, contemplated by the appended claims to cover any such modifications as incorporate those features which constitute the essential features within the true spirit and scope of the invention. All references cited herein are herby incorporated by reference in their entireties.

What is claimed is:

1. A method for controlling the spread of the citrus greening disease, by controlling the disease vector, the Asian citrus psyllid, the method comprising: applying to at least one citrus tree an effective amount of a repellant composition comprising a guava tree extract composition.

2. The method of claim 1, wherein the guava tree extract composition included a volatile compound from a guava tree, water, and optionally, a surfactant.

3. The method of claim 1, wherein the guava tree extract is microencapsulated within a biodegradable shell.

4. The method of claim 1, wherein the volatile compound is a natural extract from the guava tree.

5. The method of claim 3, wherein the volatile compound from a guava tree is derived from the fruit, the leaves or the bark of the guava tree.

6. The method of claim 1, wherein the volatile compound is a synthetic compound identical to the natural extract from the guava tree.

7. A composition for repelling Asian citrus psyllids from trees that may become infected with citrus greening disease, comprising at least one guava tree extract volatile compound and a carrier, wherein the guava tree extract is present in an amount between approximately 10% and 0.01% v/v.

8. The composition of claim 6, further comprising a surfactant present in an amount between approximately 1.0% and 0.1% v/v.

9. The composition of claim 7, wherein the volatile compound is a natural extract from the guava tree.

10. The composition of claim 7, wherein the volatile compound is a natural extract from the guava tree.

11. The composition of claim 10, wherein the volatile compound from a guava tree is derived from the fruit, the leaves or the bark of the guava tree.

12. The composition of claim 7, wherein the volatile compound is a synthetic compound identical to the natural extract from the guava tree.

13. A method for controlling the spread of the citrus greening disease, by controlling the disease vector, the Asian citrus psyllid, the method comprising: trapping one gender of the vector in traps using an effective amount of an attractant composition comprising a guava tree extract composition.

14. The method of claim 13, wherein the volatile compound is a natural extract from the guava tree.

15. The method of claim 14, wherein the volatile compound from a guava tree is derived from the fruit, the leaves or the bark of the guava tree.

16. The method of claim 13, wherein the volatile compound is a synthetic compound identical to the natural extract from the guava tree.

17. A composition for controlling Asian citrus psyllids, comprising at least one guava tree extract volatile compound that attracts Asian citrus psyllids, wherein the guava tree extract is present in an amount between approximately 5% and 0.005%

18. The composition of claim 17, wherein the volatile compound is a natural extract from the guava tree.

19. The composition of claim 17, wherein the volatile compound is a synthetic compound identical to the natural extract from the guava tree.

20. A trap for capturing Asian citrus psyllids comprising the composition of claim 17, further comprising a yellow material coated with a sticky adhesive.
